(19) United States
(12) Patent Application Publication
(10) Pub. No.: US 2013/0160521 A1
(43) Pub. Date: Jun. 27, 2013

(54) SYSTEM AND METHOD OF GENERATING SELECTIVE CATALYST REDUCTION DOSING ESTIMATE FOR A DIESEL ENGINE

(71) Applicants: Andrei Makartchouk, Hinsdale, IL (US); Raj Kumar, Des Plaines, IL (US)

(72) Inventors: Andrei Makartchouk, Hinsdale, IL (US); Raj Kumar, Des Plaines, IL (US)

(73) Assignee: INTERNATIONAL ENGINE INTELLECTUAL PROPERTY COMPANY, LLC, Lisle, IL (US)

(21) Appl. No.: 13/806,210

(22) PCT Filed: Jun. 30, 2010
(86) PCT No.: PCT/US2010/040635

§ 371 Date: Dec. 21, 2012

(51) Int. Cl. G01M 15/08

(52) U.S. Cl. CPC G01M 15/08
USPC 73/23.31

(57) ABSTRACT

A control system for an engine having an in-cylinder pressure sensor and a selective catalytic reduction device comprises an electronic control module and an in-cylinder pressure sensor. The electronic control module has a processor and a memory. The in-cylinder pressure sensor is disposed in fluid communication with a cylinder of an engine. The incylinder pressure sensor is disposed in communication with the electronic control module. The in-cylinder pressure sensor generates an output indicative of a pressure within the cylinder of the engine. The processor of the electronic control module is programmed to generate an estimate of an amount of NOx produced during combustion, and calculate an amount of reductant required to react with the NOx to limit NOx emissions to a predetermined level.

### TECHNICAL FIELD

The present disclosure relates to a system and method of generating a selective catalyst reduction dosing estimate for a diesel engine, such as to reduce nitrogen oxide (NOx) emissions of the engine, and more particularly to a system and method for generating a selective catalyst reduction dosing estimate for a diesel engine using an in-cylinder pressure sensor.

### BACKGROUND

Many modern diesel engines have an exhaust system that features a selective catalyst reduction (SCR) device disposed within the exhaust system in order to reduce a level of NOx emissions that are released into the atmosphere. Many SCR devices utilize a NOx reductant, such as ammonia in the form of an aqueous urea solution, to react with the NOx and convert the NOx in the exhaust into nitrogen and water. The level of NOx within the exhaust may vary greatly based upon engine operating conditions. In order to avoid providing an abundance of NOx reductant to the SCR, so as to prevent an excessive amount of reductant from being released into the atmosphere or from damaging the SCR, the amount of NOx within the exhaust must be accurately measured or estimated. Currently, at least one NOx sensor is typically disposed within the exhaust system to generate a measurement of the NOx present within the exhaust, such that an estimate of the amount of NOx reductant required by the SCR may be generated. However, NOx sensors add costs and complexity to the engine. Therefore, a need exists for a system and method to accurately estimate an amount of NOx within the exhaust system without using a NOx sensor.

### SUMMARY

According to one embodiment, an engine has an electronic control module and at least one in-cylinder pressure sensor, the electronic control module has programming to execute a method of estimating an amount of NOx generated during combustion of a diesel engine. The method monitors pressure within a cylinder over a combustion cycle using an in-cylinder pressure sensor. A value indicative of a mass-fraction of fuel combusted during each crank angle of the combustion cycle is generated based upon the monitoring of pressure within the cylinder and volumetric properties of the cylinder over the combustion cycle. An oxygen concentration during each crank angle is calculated based upon the mass-fraction of fuel combusted during each crank angle of the combustion cycle. A nitrogen concentration during each crank angle is calculated based upon the mass-fraction of fuel combusted during each crank angle of the combustion cycle. A flame temperature during each crank angle is calculated based upon the mass-fraction of fuel combusted during each crank angle of the combustion cycle. A rate coefficient is calculated based upon the calculated flame temperature. An equilibrium constant for an oxygen dissociation reaction is calculated based upon the calculated flame temperature. An estimated amount of NOx produced during a combustion cycle is determined using a Zeldovich Mechanism based upon the calculated oxygen concentration, the calculated nitrogen concentration, the calculated flame temperature, the calculated rate coefficient, and the calculated equilibrium constant over the combustion cycle.

According to another embodiment a physical computer program product, comprising a computer usable medium having an executable computer readable program code embodied therein, the executable computer readable program code for implementing a method of estimating an amount of NOx produced during a combustion cycle. The method monitors pressure within a cylinder over a combustion cycle using an in-cylinder pressure sensor. A value indicative of a mass-fraction of fuel combusted during each crank angle of the combustion cycle is generated based upon the monitoring of pressure within the cylinder and volumetric properties of the cylinder over the combustion cycle. An oxygen concentration during each crank angle is calculated based upon the mass-fraction of fuel combusted during each crank angle of the combustion cycle. A nitrogen concentration during each crank angle is calculated based upon the mass-fraction of fuel combusted during each crank angle of the combustion cycle. A flame temperature during each crank angle is calculated based upon the mass-fraction of fuel combusted during each crank angle of the combustion cycle. A rate coefficient is calculated based upon the calculated flame temperature. An equilibrium constant for an oxygen dissociation reaction is calculated based upon the calculated flame temperature. An estimated amount of NOx produced during a combustion cycle is determined using a Zeldovich Mechanism based upon the calculated oxygen concentration, the calculated nitrogen concentration, the calculated flame temperature, the calculated rate coefficient, and the calculated equilibrium constant over the combustion cycle.

According to a further embodiment, a control system for an engine having an in-cylinder pressure sensor and a selective catalytic reduction device comprises an electronic control module and an in-cylinder pressure sensor. The electronic control module has a processor and a memory. The in-cylinder pressure sensor is disposed in fluid communication with a cylinder of an engine. The in-cylinder pressure sensor is disposed in communication with the electronic control module. The in-cylinder pressure sensor generates an output indicative of a pressure within the cylinder of the engine. The processor of the electronic control module is programmed to generate an estimate of an amount of NOx produced during combustion based upon the output of the in-cylinder pressure sensor, and calculate an amount of reductant required to react with the NOx to limit NOx emissions to a predetermined level.

### BRIEF DESCRIPTION OF THE DRAWINGS

FIG. 1 is a schematic diagram showing an engine having an exhaust system with an SCR device and an in-cylinder pressure sensor.

FIG. 2 is a schematic diagram showing a method of calculating an amount of redactant required for an SCR device.

### DETAILED DESCRIPTION

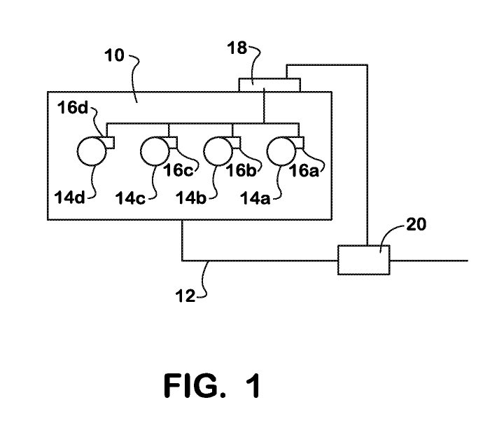

FIG. 1 shows an engine 10 having an exhaust system 12, a plurality of cylinders 14a-14d, a plurality of in-cylinder pressure sensors 16a-16d, and an electronic control module (ECM) 18. The exhaust system 12 comprises a selective catalytic reduction (SCR) device 20. The SCR device 20 injects a reductant into the exhaust gas within the exhaust system 12 that reacts with NOx within the exhaust gas and causes a chemical reaction that converts at least some of the NOx to N₂ and water. An example of one reductant that may be utilized with the SCR device 20 is an aqueous urea solution. The SCR device 20 is disposed in communication with the ECM 18. The ECM 18 controls delivery of the reductant to the SCR device 20.

The ECM 18 is additionally disposed in communication with each of the in-cylinder pressure sensors 16a-16d. The ECM 18 receives an output from the in-cylinder pressure sensor determines combustion information. The ECM 18 may adjust engine operating parameters, such as fuel injection timing, based upon the outputs of the in-cylinder pressure sensors 16a-16d. The in-cylinder pressure sensors 16a-16d monitor the pressure within the cylinders 14a-14d over the course of each combustion cycle. Based upon the pressures within the cylinders 14a-14d, and the known volume of the cylinders 14a-14d, an amount of energy released during combustion may be determined. A flame temperature at each crank angle of a combustion cycle may also be calculated by the ECM 18 utilizing the output of the in-cylinder pressure sensors 16a-16d.

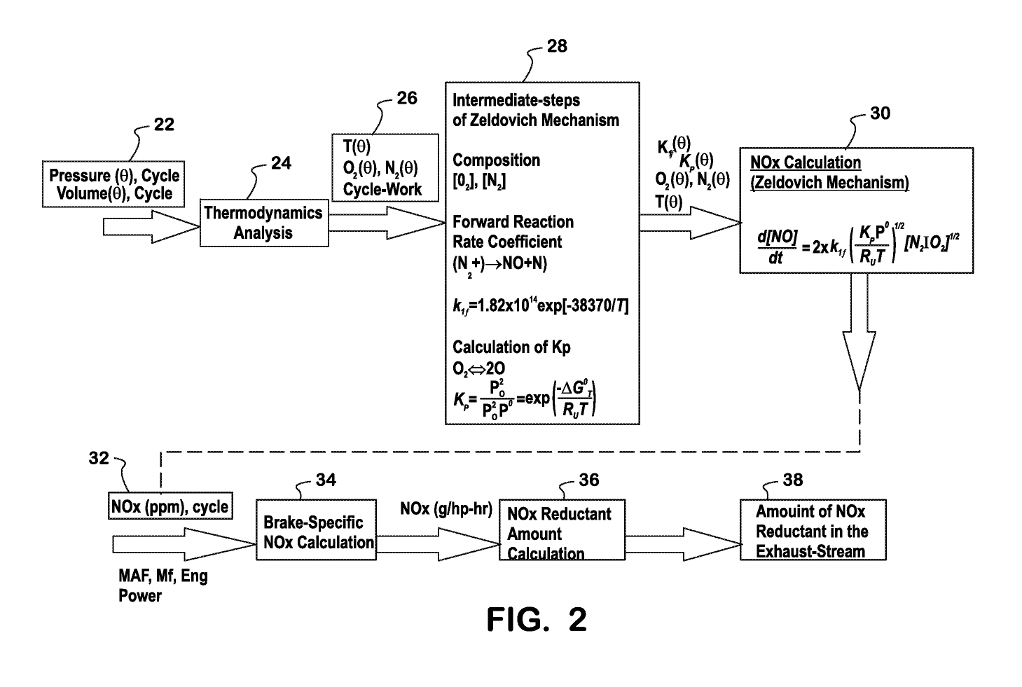

Turning to FIG. 2, in addition to the pressure at a given crank angle and the volume at a given crank angle, shown at block 22, a mass-fraction of fuel combusted during each crank angle of the combustion cycle may be calculated by the ECM utilizing the first law of thermodynamics as shown at block 24.

Using the mass-fraction fuel combusted during each crank angle of the combustion cycle, an estimate of oxygen concentration and an estimate of nitrogen concentration for each crank angle may also be calculated, as shown at block 26. The flame temperature at each crank angle is also calculated based upon the mass-fraction of the fuel combusted during each crank angle of the combustion cycle, as shown at block 26.

Once the flame temperature at each crank angle is calculated, a rate coefficient k_{1f} for use in a Zeldovich Mechanism may be calculated. Block 28 shows the rate coefficient k_{1f} being calculated using the formula: k_{1f}=1.82×10¹⁴ exp[−38370/T] where T is the flame temperature.

Additionally, block 28 shows that an equilibrium constant for an oxygen dissociation reaction Kₚ may be calculated using the formula:

$${K}_{P} = \frac{{P}_{O}^{2}}{{P}_{{O}_{2}} {P}^{0}} = exp ( \frac{- Δ {G}_{T}^{0}}{{R}_{u} T} )$$

where T is the flame temperature.

Once the rate coefficients k_{1f} and the constant Kₚ for an oxygen dissociation reaction Kₚ have been calculated, an estimate of the NOx generated for each crank angle during combustion may be determined as shown at block 30 using a Zeldovich Mechanism having the formula:

$$\frac{d [ NO ]}{d t} = 2 \times {{{k}_{1 f} ( \frac{{K}_{P} {P}^{0}}{{R}_{u} T} )}^{1 / 2} [ {N}_{2} ] [ {O}_{2} ]}^{1 / 2}$$

where k_{1f} is the constant for an oxygen dissociation reaction, P is the in-cylinder pressure, T is the flame temperature, N₂ is the mass fraction of nitrogen, and O₂ is the mass fraction of oxygen.

The NOx generated for each crank angle may be integrated over the entire combustion cycle to generate a total amount of NOx generated during the combustion cycle as shown at block 32. Using a mass flow rate of air, a mass flow rate of fuel, total engine power, and the total amount of NOx generated during the combustion cycle, a brake-specific NOx production may be determined as shown at block 34. The brake-specific NOx production is utilized to generate an amount of reductant to be injected into the exhaust system to interact with the SCR device as shown at block 36. The reductant is then injected into the exhaust system as shown at block 38.

It is contemplated that the steps shown in FIG. 2 occur within a processor of the ECM 18, although it is contemplated that additional processors may also be utilized that are in communication with the ECM 18 in order to carry out the method.

What is claimed is:

1. An engine having an electronic control module, at least one in-cylinder pressure sensor, the electronic control module programmed having programming to execute a method of estimating an amount of NOx generated during combustion of a diesel engine, the method comprising:
monitoring pressure within a cylinder over a combustion cycle using an in-cylinder pressure sensor;
generating a value indicative of a mass-fraction of fuel combusted during each crank angle of the combustion cycle based upon the monitoring of pressure within the cylinder and volumetric properties of the cylinder over the combustion cycle;
calculating an oxygen concentration during each crank angle based upon the mass-fraction of fuel combusted during each crank angle of the combustion cycle;
calculating a nitrogen concentration during each crank angle based upon the mass-fraction of fuel combusted during each crank angle of the combustion cycle;
calculating a flame temperature during each crank angle based upon the mass-fraction of fuel combusted during each crank angle of the combustion cycle;
calculating a rate coefficient based upon the calculated flame temperature;
calculating an equilibrium constant for oxygen atom dissociation reaction based upon the calculated flame temperature; and
determining an estimated amount of NOx produced during a combustion cycle using a Zeldovich Mechanism based upon the calculated oxygen concentration, the calculated nitrogen concentration, the calculated flame temperature, the calculated rate coefficient, and the calculated equilibrium constant over the combustion cycle.

2. The method of claim 1, wherein the generating the mass-fraction of fuel combusted is based upon the first law of thermodynamics.

3. The method of claim 1, wherein the rate coefficient of a Zeldovich Mechanism is calculated according to the algorithm: k_{1f}=1.82×10¹⁴ exp[−38370/T] where T is the flame temperature.

4. The method of claim 1, wherein the equilibrium constant for the oxygen dissociation reaction is calculated according to the algorithm:
$${K}_{P} = \frac{{P}_{O}^{2}}{{P}_{{O}_{2}} {P}^{0}} = exp ( \frac{- Δ {G}_{T}^{0}}{{R}_{u} T} )$$
where T is the flame temperature.

5. The method of claim 1, wherein the amount of NOx produced during a combustion cycle are estimated according to the algorithm:
$$\frac{d [ NO ]}{d t} = 2 \times {{{k}_{1 f} ( \frac{{K}_{P} {P}^{0}}{{R}_{u} T} )}^{1 / 2} [ {N}_{2} ] [ {O}_{2} ]}^{1 / 2}$$
where T is the flame temperature, Kₚ is the equilibrium constant for the oxygen atom dissociation reaction, k_{1f} is the rate coefficient of a Zeldovich Mechanism.

6. The method of claim 1 further comprising: estimating a brake-specific amount of NOx produced during combustion based upon the estimated amount of nitrogen production produced, a mass flow rate of intake air, a mass flow rate of fuel, and engine power output.

7. The method of claim 6, further comprising: estimating an amount of reductant required by a selective catalytic reduction device to reduce the brake-specific amount of NOx produced during combustion.

8. A physical computer program product, comprising a computer usable medium having an executable computer readable program code embodied therein, the executable computer readable program code for implementing a method of estimating an amount of NOx produced during a combustion cycle, the method comprising:
monitoring pressure within a cylinder over a combustion cycle using an in-cylinder pressure sensor;
generating a value indicative of a mass-fraction of fuel combusted during each crank angle of the combustion cycle based upon the monitoring of pressure within the cylinder, and volumetric properties of the cylinder over the combustion cycle;
calculating an oxygen concentration during each crank angle based upon the mass-fraction of fuel combusted during each crank angle of the combustion cycle;
calculating a nitrogen concentration during each crank angle based upon the mass-fraction of fuel combusted during each crank angle of the combustion cycle;
calculating a flame temperature during each crank angle based upon the mass-fraction of fuel combusted during each crank angle of the combustion cycle;
calculating a rate coefficient of a Zeldovich Mechanism based upon the calculated flame temperature;
calculating an equilibrium constant for an oxygen dissociation reaction based upon the calculated flame temperature; and
determining an estimated amount of NOx produced during a combustion cycle using a Zeldovich Mechanism based upon the calculated oxygen concentration, the calculated nitrogen concentration, the calculated flame temperature, the calculated rate coefficient, and the calculated equilibrium constant over the combustion cycle.

9. The physical computer program product of claim 8, wherein the generating the mass-fraction of fuel combusted is based upon the first law of thermodynamics.

10. The physical computer program product of claim 8, wherein the rate coefficient of a Zeldovich mechanism is calculated according to the algorithm: k_{1f}=1.82×10¹⁴ exp[−38370/T] where T is the flame temperature.

11. A control system for an engine having an in-cylinder pressure sensor and a selective catalytic reduction device comprising:
an electronic control module having a processor and a memory; and
an in-cylinder pressure sensor disposed in fluid communication with a cylinder of an engine, the in-cylinder pressure sensor being disposed in communication with the electronic control module, wherein the in-cylinder pressure sensor generates an output indicative of a pressure within the cylinder of the engine, and the processor of the electronic control module being programmed to generate an estimate of an amount of NOx produced during combustion, and calculate an amount of reductant required to react with the NOx to limit NOx emissions to a predetermined level.

12. The control system of claim 11, wherein the processor of the electronic control module generates a mass-fraction of fuel combusted during each crank angle of the combustion cycle based upon the monitoring of pressure within the cylinder, and volumetric properties of the cylinder over the combustion cycle.

13. The control system of claim 11, wherein the processor of the electronic control module calculates an oxygen concentration during each crank angle based upon the mass-fraction of fuel combusted during each crank angle of the combustion cycle.

14. The control system of claim 11, wherein the processor of the electronic control module calculates a nitrogen concentration during each crank angle based upon the mass-fraction of fuel combusted during each crank angle of the combustion cycle.

15. The control system of claim 11, wherein the processor of the electronic control module calculates a flame temperature during each crank angle based upon the mass-fraction of fuel combusted during each crank angle of the combustion cycle.

16. The control system of claim 11, wherein the processor of the electronic control module calculates a rate coefficient based upon the calculated flame temperature.

17. The control system of claim 11, wherein the processor of the electronic control module calculates an equilibrium constant for oxygen atom dissociation reaction based upon the calculated flame temperature.

18. The control system of claim 11, wherein the processor of the electronic control module estimates an amount of NOx produced during a combustion cycle using a Zeldovich Mechanism based upon the calculated oxygen concentration, the calculated nitrogen concentration, the calculated flame temperature, the calculate rate coefficient, and the calculated equilibrium constant over the combustion cycle.
